(19) United States
(12) Patent Application Publication
(10) Pub. No.: US 2026/0186907 A1
(43) Pub. Date: Jul. 2, 2026

(54) MEMORY SYSTEM AND METHOD FOR GENERATING A CHECKPOINT OF A MEMORY DEVICE

(71) Applicant: Ferroelectric Memory GmbH, Dresden (DE)

(72) Inventors: Maher Amer, Nepean (CA); Torsten Coym, Dresden (DE)

(21) Appl. No.: 19/004,569

(22) Filed: Dec. 30, 2024

(51) Int. Cl. G06F 11/14; G06F 11/20; G06F 13/16

(52) U.S. Cl. CPC G06F 11/141; G06F 11/2084; G06F 13/1673

(57) ABSTRACT

Various aspects relate to a memory system including: a memory configured to store respective page data for each of a plurality of pages; a non-volatile first-in first-out, FIFO, buffer; a controller configured to carry out a checkpoint operation in response to a checkpoint command; a storage configured to store a page table including a page table entry for each page, the page table entry indicating whether the page was updated after receiving the checkpoint command; the checkpoint operation including: generating a page table copy of the page table; in response to receiving data that are to be written to a page, if, in the page table copy, the page table entry of the page indicates that the page was not updated: storing the data in the hardware FIFO buffer, generating a page data copy of the page data of the page, and merging the data with the page data copy.

### TECHNICAL FIELD

Various aspects relate to a memory system (e.g., a memory module) and a method for generating a checkpoint of a memory device.

### BACKGROUND

In general, various computer memory technologies have been developed in semiconductor industry. Various applications rely on a direct access of a volatile memory to non-persistently store data. An exemplary application is the training of machine-learning models during which the model parameters (hyperparameters, weights, etc.) are stored in the volatile memory. However, since a volatile memory requires constant power in order to store data, the data may be lost in the scenario of a power loss. For example, in the case of the training of the machine-learning model, all model parameters would be lost and the training has to start from scratch. Therefore, it may be required to persistently store a current state of the volatile memory in regular intervals. For this, a checkpoint of the volatile memory may be generated by storing the current status of the volatile memory in a non-volatile storage. However, the checkpointing (viz. the generation of the checkpoint) generates large amounts of data, puts heavy demands on the non-volatile storage, the data transfer may create input/output (I/O) bottlenecks, etc. which reduces the performance of the system (e.g., in the case of the training of the machine-learning model it slows down the training process), limits the frequency at which checkpoints can be generated, and the size of the checkpoints strains the non-volatile storage performance and may result in costly disruptions.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 schematically shows a compute node architecture for training a machine-learning model;

FIG. 2A and FIG. 2B show various aspects of a software-based generation of a checkpoint of a memory device;

FIG. 3 shows a memory module including a (non-volatile) hardware FIFO buffer according to various aspects;

FIG. 4A to FIG. 4D show various aspects of a checkpoint operation for generating a checkpoint of the memory device; and

FIG. 5 shows a flow diagram of a method for generating a checkpoint of a memory device according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a memory cell, or a memory capacitor). However, it may be understood that aspects described in connection with methods may similarly apply to the devices, and vice versa.

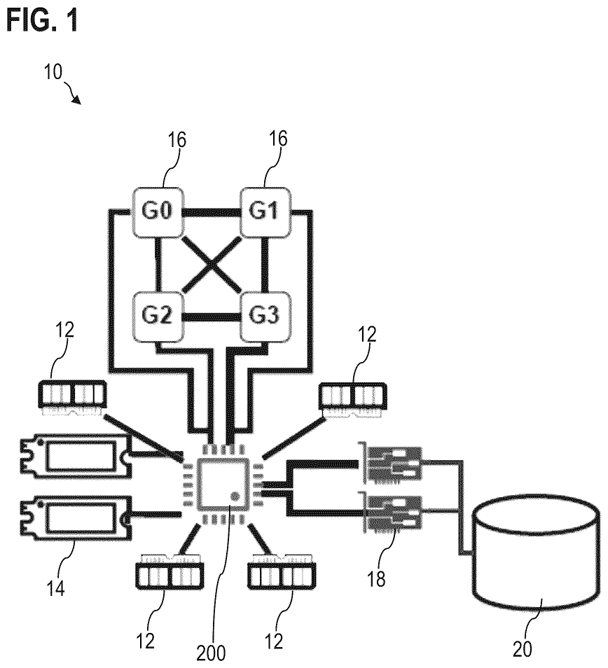

Various applications rely on a direct access of a (often volatile) memory device to non-persistently store data. In the following, various aspects of a direct memory access are detailed with reference to FIG. 1 exemplarily for a compute node architecture 10 for training a machine-learning model. It is understood that this serves as an example and that the checkpointing detailed herein can be employed for any kind of memory system directly accessing a memory device.

The compute node architecture 10 may include a processing unit 200 (e.g., being or including one or more processors), graphics processing units 16 (G0, G1, G2, G3) (e.g., coupled with each other via NVLink) for running the calculations of the machine-learning model (e.g., by implementing the layers thereof, such as the transformer layers in the case that the machine-learning model is a Transformer model, e.g., of a Large Language Model, LLM). The compute node architecture 10 may include at least one (e.g., multiple) memory device 12, wherein each of them may be checkpointed according to the checkpoint operation detailed herein). The compute node architecture 10 may include at least one non-volatile storage device 14 (on which the data of the memory device 12 are stored responsive to the checkpoint operation). Each non-volatile storage device 14 may, for example, be an SSD. The compute node architecture 10 may include at least one network interface 18 coupled, via a network, to a persistent storage 20 (for persistent data storage).

As detailed herein, the model parameters of the machine-learning model may, during training, be stored in the one or more memory devices 12. However, in the scenario of a power loss, all data may be lost and the training has to start from scratch. Therefore, a checkpoint (may also be referred to as snapshot) of each memory device 12 may be generated in regular intervals by storing the current status of the respective memory device 12 in the non-volatile storage device 20. This allows to recover the model parameters of the machine-learning model in the event of failure.

There are various approaches of implementing the checkpointing of a memory device. A. Maurya et al.: “DataStates-LLM: Lazy Asynchronous Checkpointing for Large Language Models”, arXiv:2406.10707, 2024 [in the following referred to as reference [1]) describes different checkpointing approaches. All those checkpointing approaches are software-based.

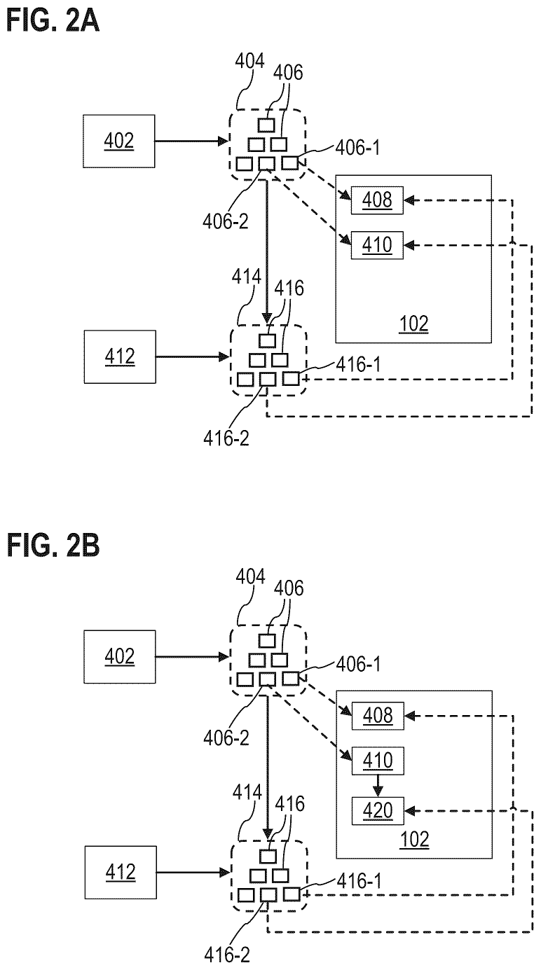

FIG. 2A and FIG. 2B show various aspects of an exemplary software-based generation of a checkpoint of the memory device 12.

As detailed herein, each namespace may be associated with a corresponding page table including a plurality of page table entries, with each page table entry of the plurality of page table entries being bijectively assigned to specific page data and indicating the logical address used by the processing unit 200 application for accessing the page data and the physical address indicating the page at which the page data are stored in the memory system.

With reference to FIG. 2A, a process 402 may be configured to write data to the memory device 12. The system may include a (e.g., namespace-specific) page table 404 including a plurality of page table entries 406. The plurality of page table entries 406 may include a first page table entry 406-1 indicating (e.g., pointing to) a first page 408 of the memory device 102 and may include a second page table entry 406-2 indicating (e.g., pointing to) a second page 410 of the memory device 12.

In response to receiving a checkpoint command for generating a checkpoint of the memory device 12, all pages of the memory device 12 may be marked as read-only. Hence, they cannot be overwritten anymore. Further, caches may be invalidated. The process 402 may be forked to obtain a child process 412. The child process 412 may have a page table copy 414 generated by copying the page table 404. Thus, initially (viz. when generated), the page table entries 416 of the page table copy 414 are the same as the page table entries 406 of the page table 404. Hence, a first page table entry 416-1 may indicate (e.g., point to) the first page 408 and a second page table entry 416-2 may indicate (e.g., point to) the second page 410 of the memory device 12.

With reference to FIG. 2B, in the case that new data are to be written to the memory device 12, e.g., to the second page 410, the (parent) process 402 will fault (since the pages are set as read-only) and may trigger to generate a copy of the page data (viz. a page data copy) of the second page 410 by copying the page data to a third page 420. The data to be written may then be written to the third page 420. The second page table entry 416-2 of the page table copy 414 may then be updated to indicate (e.g., point to) the third page 420.

However, since this kind of checkpointing is software-based, performance of the system is reduced (e.g., in the case of the training of the machine-learning model it slows down the training process), wherefore, for example, the frequency at which checkpoints can be generated is limited. Thus, the software-based checkpointing approaches rely extensively on software frameworks and general-purpose operating system services (including file systems, process and memory management, etc.). While these solutions offer flexibility, they result in a reduced performance due to their overhead costs.

The checkpoint operation detailed herein allows the checkpointing of a memory device with improved performance.

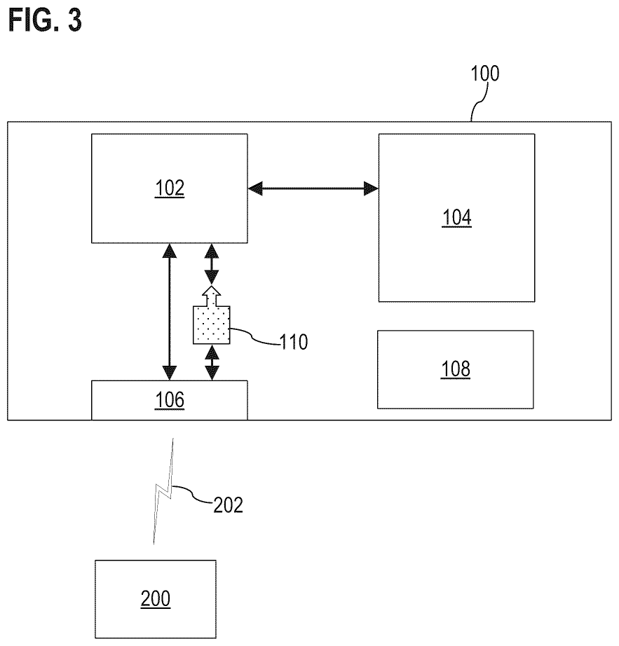

FIG. 3 shows a memory module 100 according to various aspects. This memory module 100 allows to improve the performance by providing a hardware-based checkpointing of the memory device 102. Thus, the checkpointing is moved to hardware, thereby not limiting the performance during checkpointing. This allows, for example, to generate checkpoints more frequently. For illustration, FIG. 3 shows the memory module 100 as including both, a memory device 102 and a non-volatile storage device 104. It is understood that this serves for illustration and that the checkpoint operation may be applied accordingly in the case that the non-volatile memory device 102 and the non-volatile storage device 104 are separate devices not part of a same memory module.

The memory module 100 detailed herein may be configured to persistently store data. Hence, illustratively, the memory module 100 may provide data storage.

The term “storage”, as used herein, may refer to a unit configured to persistently, viz. non-volatilely, store data. Illustratively, the non-volatile storage device 104 may serve for permanent data storage. Thus, the non-volatile storage device 104 may store the data also once the power is removed. As an example, the non-volatile storage device 104 may be a non-volatile flash storage, such as a non-volatile NAND flash storage. It is understood that this serves as an example for illustration and that the memory cells of the non-volatile storage device 104 may have any other kind of configuration.

The term “memory”, as used herein, may refer to a unit allowing for a volatile data access. A volatile memory may require constant power in order to store data. Thus, once the power is lost, the stored data are gone. Hence, a volatile memory may store data non-persistently. Since the memory device 102 is a non-volatile memory device 102 (in various aspects described in short as memory device 102), the memory device 102 is capable to persistently store data.

The memory module 100 may include a memory controller 108. The memory controller 108 may be configured to control the units of the memory module 100. Thus, the memory controller 108 may be, for example, configured to control read and/or write operations on the memory module 100. Herein, when referring to an action being carried out by at least one of the elements of the memory module 100, the memory controller 108 may be configured to control the at least one element accordingly.

The memory module 100 may include a memory interface 106. The memory interface 106 may be configured to receive data from a host 200 (e.g., a processing unit (e.g., a central processing unit), e.g., of a user device) via a communication channel 202 (e.g., to write the data to the memory module 100). The memory interface 106 may be configured to transmit data to the host 200 via the communication channel 202 (e.g., to provide data that are read from the memory module 100 responsive to the host 200 requesting them). The processing unit of the host 200 may implement an application interacting with the memory module 100 via the memory interface 106.

The memory interface 106 may be any kind of interface that allows to directly address the memory device 102. As an example, the memory interface 106 may be a Compute Express Link (CXL) interface.

Compute Express Link (CXL) is an open standard interconnect for high-speed, high-capacity central processing unit (CPU)-to-device and CPU-to-memory connections, designed for high performance data center computers. CXL is built on the serial PCI Express (PCIe) physical and electrical interface and includes PCIe-based block input/output protocol (CXL.io) and cache-coherent protocols for accessing system memory (CXL.cache) and device memory (CXL.mem).

Compute Express Link (CXL) includes a CXL input/output (CXL.io) protocol that allows to address the memory module 100 to, for example, provide new page data (e.g., of 4 kB size) that are to be written to the memory module 104 and/or to provide other data, such as registration data for registering a namespace, etc. Further CXL includes a CXL memory (CXL.mem) protocol that allows to directly address the memory device 102 (with up to 64 kB). According to various aspects, the memory device 102 may be a byte-addressable memory. The CXL.mem protocol is an example of providing the byte-addressability of the memory device 102. It is understood that this serves as an exemplary protocol and that any other protocol may be used that allows to directly (byte-) address the memory device 102. The memory device 102 may also be referred to as host-managed device memory (HDM).

For accessing the memory module 100, the memory module 100 may include a page table including a plurality of page table entries (PTE). Each page table entry of the plurality of page table entries may be (bijectively) associated with a page of the non-volatile memory device 102. Each page table entry may indicate a physical address of the memory device 102 and a logical (e.g., virtual) address thereof.

According to various aspects, the memory module 100 may include a hardware first-in first-out (FIFO) buffer 110. The hardware FIFO buffer 110 may be configured to store data persistently. In the following, the non-volatile memory device 102 is described as providing the hardware FIFO buffer 110. Hence, a memory portion of the non-volatile memory device 102 may be dedicated to provide the hardware FIFO buffer 110. Implementing the hardware FIFO buffer 110 as a portion of the non-volatile memory device 102 may be advantageous since both, the non-volatile memory device 102 and the hardware FIFO buffer 110 may be required to be non-volatile (viz. persistent), byte-addressable, and comparatively fast (e.g., similar to DRAM). It is understood that this is an advantageous implementation and that the hardware FIFO buffer 110 may be implemented as a hardware device separate to the non-volatile memory device 102. Hence, according to various aspects, the hardware FIFO buffer 110 may be implemented physically in any suitable manner as long as the hardware FIFO buffer 110 is byte-addressable and configured to store data persistently.

As an example of the non-volatile memory device 102, the memory cells of the memory device 102 may be remanent-polarizable memory cells. A remanent-polarizable memory cell may be writable into at least two (different) remanent polarizable memory states. For this, the memory cell may include a capacitive memory structure, such as a spontaneously polarizable capacitor, SPOC, structure. Therefore, the memory cell may also be referred to as a capacitive memory cell or a capacitor-type memory cell. The SPOC structure may include at least one capacitor. The capacitor may include a memory element disposed between at least two electrodes (e.g., two electrode layers). The SPOC structure may include the at least one capacitor and an access transistor. For example, the memory cell may be a one transistor, T, one capacitor, C, memory cell (1T1C cell). It is understood that this serves for illustration and that the memory cell may include more than one capacitor, thus being a one transistor multiple capacitors memory cell (1TxC cell). Thus, the memory state of the memory cell may be associated with a (remanent) polarization state of the SPOC structure. The (remanent) polarization state of the SPOC may determine the amount of charge stored therein. The amount of charge stored in the SPOC structure may be used to define the memory state of the memory cell. Thus, writing the memory cell may be associated with applying an electric field over the SPOC structure to thereby set (e.g., change) the (e.g., remanent) polarization state of the SPOC structure.

The memory element of the SPOC structure may include or may consist of a spontaneously polarizable material. For example, the spontaneously polarizable material may be a remanent polarizable material, such as a ferroelectric material, or a non-remanent polarizable material, such as an anti-ferroelectric material. A memory element including or consisting of a spontaneously polarizable material may be understood such that the memory element has (e.g., within the framework of the SPOC structure) spontaneously polarizable properties. Thus, the SPOC structure may provide a spontaneously polarizable capacitor (in some aspects also referred to as memory capacitor).

The spontaneously-polarizable memory element may show a hysteresis in the (voltage (drop) dependent) polarization. The spontaneously-polarizable memory element may show non-remanent spontaneous polarization (e.g., may show anti-ferroelectric properties), e.g., the spontaneously-polarizable memory element may have no or no substantial remanent polarization remaining in the case that no voltage drops over the spontaneously-polarizable memory element. In other aspects, the spontaneously-polarizable memory element may show remanent spontaneous polarization (e.g., may show ferroelectric properties), e.g., the spontaneously-polarizable memory element may have a remanent polarization or a substantial remanent polarization remaining in the case that no voltage drops over the spontaneously-polarizable memory element.

The terms “spontaneously polarized” or “spontaneous polarization” may be used herein, for example, with reference to the polarization capability of a material beyond dielectric polarization. A “spontaneously-polarizable” (or “spontaneous-polarizable”) material may be or may include a spontaneously-polarizable material that shows a remanence, e.g., a ferroelectric material, and/or a spontaneously-polarizable material that shows no remanence, e.g., an anti-ferroelectric material. The coercivity of the spontaneously-polarizable material may be a measure of the strength of the reverse polarizing electric field that may be required to remove a remanent polarization. In some aspects, the memory element may be remanent-polarizable, thereby providing the remanent polarization capability of the SPOC structure. In other aspects, the memory element may consist of a material that is spontaneously polarizable but shows no remanence (e.g., an anti-ferroelectric material) and additional conditions are implemented to generate an internal electric-field within the anti-ferroelectric material to thereby provide the remanent polarization capability of the SPOC structure. Hence, a non-remanent polarizable material, such as an anti-ferroelectric (“antiferroelectric”) material may exhibit remanent polarizable properties within certain structures. An internal electric-field within an anti-ferroelectric material may be caused (e.g., applied, generated, maintained, as examples) by various strategies: e.g., by implementing floating nodes that may be charged to voltages different from zero volts, and/or by implementing charge storage layers, and/or by using doped layers, and/or by using electrode layers that adapt electronic work-functions to generate an internal electric field, by using an encapsulation structure which introduces compressive stress or tensile stress onto the memory element, thereby establishing the spontaneously polarizable properties, only as examples.

A spontaneous polarization (e.g., a remanent or non-remanent spontaneous polarization) may be evaluated via analyzing one or more hysteresis measurements (e.g., hysteresis curves), e.g., in a plot of polarization, P, versus electric field, E, in which the material is polarized into opposite directions. The polarization capability of a material (dielectric polarization, spontaneous polarization, and a remanence characteristics of the polarization) may be analyzed using capacity spectroscopy, e.g., via a static (C-V) and/or time-resolved measurement or by polarization-voltage (P-V) or positive-up-negative-down (PUND) measurements. Another method for determining a polarization capability of a state-programmable memory element may include transmission electron microscopy, e.g., an electric-field dependent transmission electron microscopy.

Hence, according to various aspects, the memory device 102 may be a remanent-polarizable memory, such as a remanent-polarizable non-volatile random-access memory. As an example, the remanent-polarizable non-volatile random-access memory may be a ferroelectric non-volatile random-access memory, FeNVRAM. According to other aspects, the memory device 102 may be a magnetoresistive random-access memory (MRAM) or a resistive random-access memory (RRAM). It is understood that these non-volatile memories serve as examples and that the memory device 102 may be any other kind of non-volatile memory.

As detailed herein, for example in the case of training the machine-learning model, the processing unit 200 may write data to the memory device 102.

At some point, the memory module 100 may, via the memory interface 106, receive a checkpoint command instructing the memory module 100 to generate a checkpoint of the memory device 102. The memory controller 108 may be configured to, in response to receiving the checkpoint command, carry out a checkpoint operation for generating the checkpoint of the memory device 102.

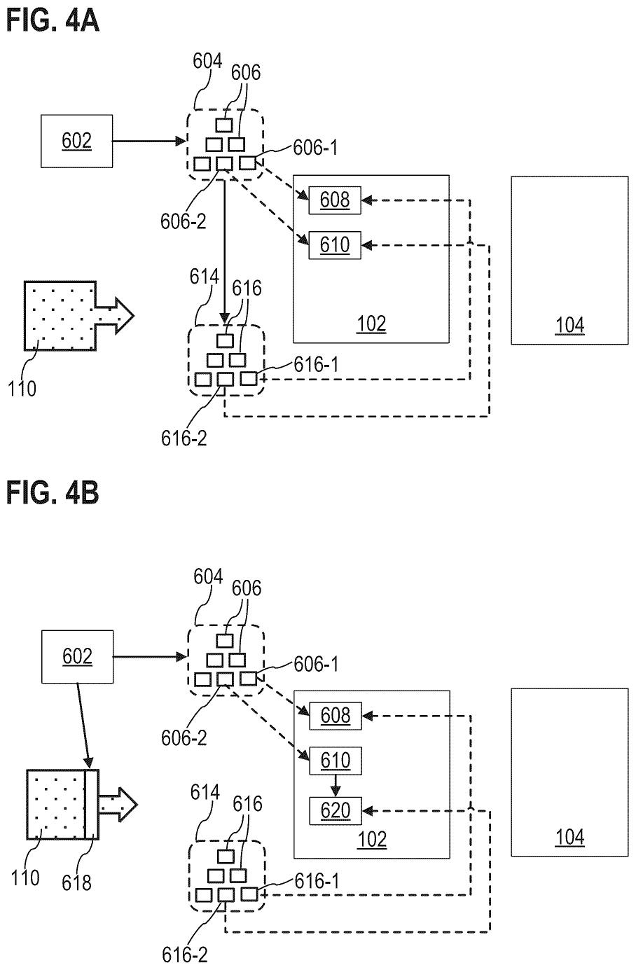

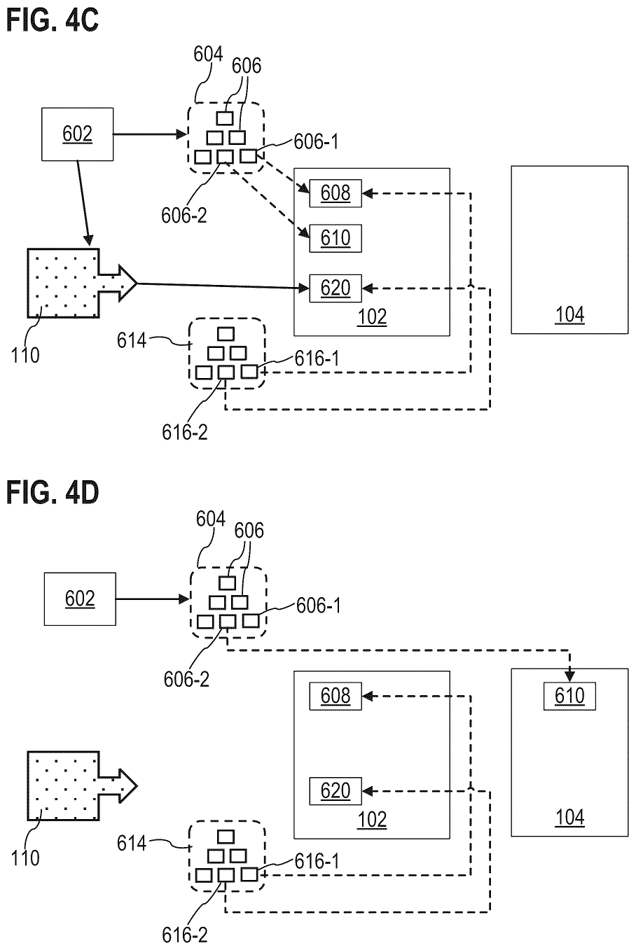

FIG. 4A to FIG. 4D show various aspects of the checkpoint operation for generating a checkpoint, i, of the memory device 102 according to various aspects.

Similar to the process 402 described with reference to FIG. 2A, there may be a process 602 configured to write data to the memory device 102 and the memory module 100 may include a (e.g., namespace-specific) page table 604 including a plurality of page table entries 606. For example, the plurality of page table entries 606 may include a first page table entry 606-1 indicating (e.g., pointing to) a first page 608 of the memory device 102 and may include a second page table entry 606-2 indicating (e.g., pointing to) a second page 610 of the memory device 102.

In contrast to the software-based approach of FIG. 2A and FIG. 2B, no child process may be generated in response to receiving the checkpoint command and the pages of the memory device 102 may not be marked as read-only.

With reference to FIG. 4A, in response to receiving the checkpoint command (e.g., via the CXL.io protocol), the memory controller 108 may be configured to generate a page table copy 614 by copying the page table 604. Hence, the checkpoint operation may include the generation the page table copy 614 by copying the page table 604. Thus, initially (viz. when generated), the page table entries 616 of the page table copy 614 are the same as the page table entries 606 of the page table 604. Hence, a first page table entry 616-1 may indicate (e.g., point to) the first page 608 and a second page table entry 616-2 may indicate (e.g., point to) the second page 610 stored in the memory device 102.

The page table 604 may be associated with the (current) checkpoint, i, (viz. the checkpoint to be generated by the checkpoint operation) and the page table copy 614 may be associated with a next checkpoint, i+1 (or vice versa). In the following, the page table 604 is described to be associated with the (current) checkpoint, i, and the page table copy 614 is described to be associated with the next checkpoint, i+1. It is understood that, since when generated, the page table 604 and the page table copy 614 are the same, the assignment may also be the other way around (viz. the page table copy 614 may be associated with the checkpoint, i, and the page table 604 with the next checkpoint, i+1). To indicate the checkpoint the respective page table 604, 614 is associated with, each page table 604, 614 may include a checkpoint reference (e.g., a checkpoint reference number Ref #) indicating the associated checkpoint (viz. i+1 for the page table copy 614 and i for page table 604 in the present example). Thus, the memory controller 108 may adapt the checkpoint reference of the page table copy 614 to indicate the next checkpoint, i+1. In the example, of the reference number Ref #, the memory controller 108 may increment the number by one (e.g., Ref #=i+1).

Each page table entry of each page table 604, 614 may further indicate (e.g., by a checkpoint identifier) whether the corresponding page was updated after receiving the checkpoint command. For example, each page table entry may include the checkpoint identifier indicating checkpoint, i, in the case that the page data were not (yet) updated after receiving the checkpoint command and indicating the next checkpoint, i+1, in the case that the page data were updated after receiving the checkpoint command. Thus, when initially generated, the page table entries of the page table copy 614 may all indicated the checkpoint, i, since there was no update yet.

The checkpoint operation may include that, in response to receiving (e.g., via the memory interface) data that are to be written to a page of the memory device 102, and in the case that, in the page table copy 614, the respective page table entry of a page indicates that the page was not updated after receiving the checkpoint command, the memory controller 108 may be configured to store the data in the hardware FIFO buffer 110.

Thus, with reference to FIG. 4B, the checkpoint operation may include that, in response to receiving data 618 that are to be written to the second page 610 and since initially the second page table entry 616-2 indicates that the second page 610 was not updated after receiving the checkpoint command, the memory controller 108 may store the data 618 in the hardware FIFO buffer 110.

According to various aspects, the page table 614 may be configured to indicate (e.g., point to) (e.g., an entry of) the hardware FIFO buffer 110. Thus, the second page table entry 616-2 of the page table copy 614 may also point to the data 618 in the hardware FIFO buffer 110.

The checkpoint operation may then include to the generation of a page data copy in the memory device 102 by copying the page data of the second page 610 to a new physical address of the memory device 102, viz. to a third page 620. The second page table entry 616-2 in the page table copy 614 may then be updated to point to the third page 620 having the new physical address. The second page table entry 606-2 in the page table 604 (pointing to the second page 610) is not updated.

With reference to FIG. 4C, the data 618 may then be written to (e.g., merged with) the page data of the third page 620. Illustratively, whenever page data of a page that belongs to the current checkpoint (which may after the checkpoint operation referred to as prior checkpoint) are to be updated, the page data are first copied to another location of the memory device 102 and are then updated, thereby ensuring that the page data of the current checkpoint are not changed. This may also be referred to as copy-on-write operation. Further, storing the data in the hardware FIFO buffer 110 first provides the time to carry out the copy-on-write operation (viz. to copy the page data first) without any delay observed by the processing unit 200.

Then, the memory controller 108 may be configured to update the checkpoint identifier of the second page table entry 616-2 of the third page 620 in the page table copy 614 to indicate that the page data copy of the third page 620 were updated after receiving the checkpoint command. Thus, for example, the checkpoint identifier of the second page table entry 616-2 may be updated to indicate the next checkpoint, i+1. Thus, when receiving further data (prior to a further checkpoint command) that are to be written to the third page 620, no copy of the page data of the third page is generated, but the data are written to (e.g., merged with) the page data of the third page 620 directly (since the third page already belongs to the next checkpoint, i+1, and not the prior, i).

Illustratively, the checkpointing detailed herein allows to move the checkpointing background activities from software to hardware, thereby speeding up the (memory) checkpointing. Herein, the initiation of the checkpointing (e.g., by reception of the checkpoint command), the data merging during and after checkpoint generation, etc. are carried out in hardware by the memory controller 108. Also, all address resolution tasks related to the physical addresses are handled by the memory controller 108.

The checkpoint operation may include that the respective page data of all pages a page table entry 606 of the page table 604 points to are written to the non-volatile storage device 104 for persistent storage.

Each page table entry may further indicate the corresponding page to be either dirty or clean. In the case that a page is indicated as clean, the page data of the page do not have to be written the non-volatile storage device 104. Accordingly, in the case that a page is indicated as dirty, the page data of the page have to be written to (viz. are not present in) the non-volatile storage device 104. Thus, the pages to which the page table entries 606 of the page table 604 point to may be indicated as dirty.

With reference to FIG. 4D, the checkpoint operation may include to (e.g., when using the non-volatile memory device 102, opportunistically) write the page data of the second page 610 to the non-volatile storage device 104. The second page table entry 606-2 of the page table 604 may then be updated to indicate (e.g., point to) the physical address of the page in the non-volatile storage device 104 to which the page data of the second page 610 are written.

As detailed herein, there may be a respective page table for each namespace of one or more namespaces. Thus, the checkpoint operation described herein may be carried out for the page table 604 of a corresponding namespace in response to receiving the checkpoint command associated with this (corresponding) namespace. Hence, there may be one or more (e.g., multiple) checkpoint operations carried out concurrently (viz. at least partially overlapping in time).

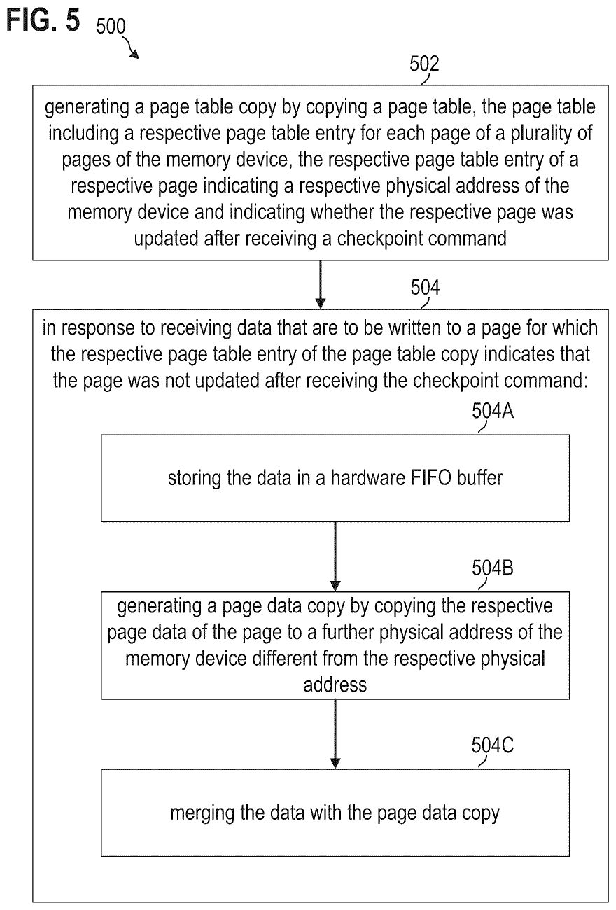

FIG. 5 shows a flow diagram of a method 500 for generating a checkpoint of a memory device (viz. a memory checkpoint) according to various aspects.

The method 500 may include (in 502) generating a page table copy by copying a page table (the page table copy being associated with a next checkpoint of the memory). The page table may include a respective page table entry for each page of a plurality of pages of the memory device. The respective page table entry of a respective page may indicate a respective physical address of the memory device and may indicate whether the respective page was updated after receiving a checkpoint command (for generating the checkpoint).

The method 500 may include (in 504) in response to receiving data that are to be written to a page for which the respective page table entry of the page table copy indicates that the page was not updated after receiving the checkpoint command:

In 504A, the method 500 may include storing the data in the hardware FIFO buffer.

In 504B, the method 500 may include generating a page data copy by copying the respective page data of the page to a further physical address of the memory device different from the respective physical address.

In 504C, the method 500 may include merging the data with the page data copy.

It may be intended that aspects described in relation to one or more of the methods may apply also to the memory system, and vice versa. For example, a method may include an execution of one or more functions described with reference to the memory system. For example, the memory controller 108 of the memory module 100 may be configured to carry out one or more aspects described herein.

In the following, various examples are provided that may include one or more aspects described above with reference to the memory module 100, the memory controller 108, and to the methods described herein. It may be intended that aspects described in relation to one or more of the methods may apply also to the memory device, and vice versa.

Example 1 is a (computer-readable) memory system (e.g., a memory module, such as the memory module 100) including: (e.g., a memory interface;) a (directly-addressable) (e.g., non-volatile) memory configured to store respective page data for each page of a plurality of pages; a non-volatile (hardware) first in first out, FIFO, buffer (e.g., provided by the non-volatile memory device); a memory controller configured to carry out a checkpoint operation in response to receiving a checkpoint command for generating a checkpoint of the memory device; a non-volatile (e.g., flash) storage for persistent data storage, the non-volatile memory device and/or the non-volatile storage device being configured to store a page table including a respective page table entry for each page of the plurality of pages, the respective page table entry of a respective page indicating a respective physical address of the memory device (and indicating a respective logical (e.g., virtual) address) and indicating whether the respective page was updated after receiving the checkpoint command (the page table may be cached to the memory); wherein the checkpoint operation includes: generating a page table copy by copying the page table (the page table copy being associated with a next checkpoint of the memory); in response to receiving (e.g., via the memory interface) data that are to be written to a page of the plurality of pages, and in the case that, in the page table copy, the respective page table entry of the page indicates that the page was not updated after receiving the checkpoint command: storing the data in the non-volatile FIFO buffer, generating a page data copy by copying the respective page data of the page to a further physical address of the non-volatile memory device different from the respective physical address, and merging the data stored in the non-volatile FIFO buffer with the page data copy.

This checkpoint operation allows to generate a checkpoint of the memory device without limiting the performance of the memory device. This is, for example, achieved by moving the checkpointing into hardware. Hence, the checkpointing is carried out completely in hardware by back-pressuring the memory controller, thereby improving the performance of the memory system.

In Example 2, the subject matter of Example 1 can optionally include that the checkpoint operation includes (when generating the page data copy) adapting, in the page table copy, the respective page table entry of the page to indicate the further physical address and/or to indicate that the page was updated after receiving the checkpoint command.

In Example 3, the subject matter of Example 1 or 2 can optionally include that the memory controller is configured to, in response to receiving (e.g., via the memory interface) the data that are to be written to the page and in the case that the respective page table entry of the page indicates that the page was updated after receiving the checkpoint command, merging the data with the page data of the page (at the further physical address) without storing them in the non-volatile FIFO buffer first.

In Example 4, the subject matter of any one of Examples 1 to 3 can optionally include that the checkpoint operation includes: for each page table entry in the page table, (opportunistically) writing the respective page data of the respective page to the non-volatile storage device after generation of the page data copy.

In Example 5, the subject matter of Example 4 can optionally include that the checkpoint operation includes when writing the respective page data of the respective page of a respective page table entry the non-volatile storage device, adapting the respective page table entry to indicate a physical address of the non-volatile storage device to which the respective page data are written.

In Example 6, the subject matter of any one of Examples 1 to 5 can optionally include that the non-volatile memory device provides the non-volatile FIFO buffer.

In Example 7, the subject matter of any one of Examples 1 to 6 can optionally include that the non-volatile memory device is or includes at least one of: a remanent-polarizable non-volatile random-access memory (e.g., a ferroelectric non-volatile memory, FeNVRAM), a magnetoresistive random-access memory (MRAM), or a resistive random-access memory (RRAM).

Using a non-volatile memory allows to opportunistically write the page data from the memory to the storage, thereby improving the performance of the memory system. Illustratively, there is no time constraint on writing the page data from the memory to the storage.

In Example 8, the subject matter of any one of Examples 1 to 7 can optionally include that the memory system includes a memory module including the non-volatile memory device, the non-volatile storage device, the memory controller, and the non-volatile FIFO buffer; and that the checkpoint command and the data are received via a memory interface of the memory module, the memory interface being a Compute Express Link (CXL) interface.

In Example 9, the subject matter of any one of Examples 1 to 8 can optionally include that the page table is associated with a corresponding namespace.

In Example 10, the subject matter of any one of Examples 1 to 9 can optionally include that the page table includes a checkpoint reference indicating which checkpoint the page table is associated with; and wherein the checkpoint operation includes adapting (e.g., incrementing) the checkpoint reference of the page table copy to indicate a next checkpoint or adapting (e.g., incrementing) the checkpoint reference of the page table to indicate the (current) checkpoint.

Example 11 is a method for generating a checkpoint of a (directly-addressable) (e.g., non-volatile) memory device, the method including: generating a page table copy by copying a page table (the page table copy being associated with a next checkpoint of the memory), the page table including a respective page table entry for each page of a plurality of pages of the memory device, the respective page table entry of a respective page indicating a respective physical address of the memory device (and indicating a respective logical (e.g., virtual) address) and indicating whether the respective page was updated after receiving a checkpoint command (viz. after initiating the generation of the checkpoint) (the page table may be cached to the memory); in response to receiving data that are to be written to a page for which the respective page table entry of the page table copy indicates that the page was not updated after receiving the checkpoint command: storing the data in a non-volatile first in first out, FIFO, buffer, generating a page data copy by copying the respective page data of the page to a further physical address of the memory device different from the respective physical address, and merging the data with the page data copy.

In Example 12, the method of Example 11 can optionally further include: adapting, in the page table copy, the respective page table entry of the page to indicate the further physical address and/or to indicate that the page was updated after receiving the checkpoint command. In Example 13, the method of Example 11 or 12 can optionally further include: in response to receiving data that are to be written to a page for which the respective page table entry of the page table copy indicates that the page was updated after receiving the checkpoint command, merging the data with the page data of the page (at the further physical address) without storing them in the non-volatile FIFO buffer first. In Example 14, the method of any one of Examples 11 to 13 can optionally further include: for each page table entry in the page table, (opportunistically) writing the respective page data of the respective page to a non-volatile storage device after generation of the page data copy. In Example 15, the method of Example 14 can optionally further include: adapting the respective page table entry to indicate a physical address of the non-volatile storage to which the respective page data are written. In Example 16, the subject matter of any one of Examples 11 to 15 can optionally include that the memory device is a non-volatile memory device providing the non-volatile FIFO buffer. In Example 17, the subject matter of any one of Examples 11 to 16 can optionally include that the memory device is a non-volatile memory device, wherein the non-volatile memory device is or includes at least one of: a remanent-polarizable non-volatile random-access memory (e.g., a ferroelectric non-volatile memory, FeNVRAM), a magnetoresistive random-access memory (MRAM), or a resistive random-access memory (RRAM).

In Example 18, the subject matter of any one of Examples 11 to 17 can optionally include that the data are received via a Compute Express Link (CXL) interface.

In Example 19, the subject matter of any one of Examples 11 to 18 can optionally include that the page table is associated with a corresponding namespace.

In Example 20, the subject matter of any one of Examples 11 to 19 can optionally include that the page table includes a checkpoint reference indicating which checkpoint the page table is associated with; and wherein the method further includes adapting (e.g., incrementing) the checkpoint reference of the page table copy to indicate a next checkpoint or adapting (e.g., incrementing) the checkpoint reference of the page table to indicate the (current) checkpoint.

The term “coupled to” used herein with reference to components of a memory device may be understood in that the components are directly or indirectly communicatively coupled to one another.

The terms “at least one” and “one or more” may be understood to include any integer number greater than or equal to one, i.e. one, two, three, four, [. . . ], etc. The term “a plurality” or “a multiplicity” may be understood to include any integer number greater than or equal to two, i.e. two, three, four, five, [. . . ], etc. The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The phrase that an element or a group of elements “includes” another element or another group of elements may be used herein to mean that the other element or other group of elements may be part of the element or the group of elements or that the element or the group of elements may be configured or formed as the other element or the other group of elements (e.g., the element may be the other element).

The phrase “unambiguously assigned” may be used herein to mean a one-to-one-assignment (e.g., allocation, e.g., correspondence) or a bijective assignment. As an example, a first element being unambiguously assigned to a second element may include that the second element is unambiguously assigned to the first element. As another example, a first group of elements being unambiguously assigned to a second group of element may include that each element of the first group of elements is unambiguously assigned to a corresponding element of the second group of elements and that that corresponding element of the second group of elements is unambiguously assigned to the element of the first group of elements.

It is noted that one or more functions described herein with reference to a memory device may be accordingly part of a method, e.g., part of a method for operating a memory device. Vice versa, one or more functions described herein with reference to a method, e.g., with reference to a method for operating a memory device, may be implemented accordingly in a device or in a part of a device, for example, by a memory controller.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

What is claimed is:

1. A memory system, comprising:
a non-volatile memory device configured to store respective page data for each page of a plurality of pages;
a non-volatile first in first out (FIFO) buffer;
a memory controller configured to carry out a checkpoint operation in response to receiving a checkpoint command for generating a checkpoint of the non-volatile memory device;
a non-volatile storage device for persistent data storage, the non-volatile memory device and/or the non-volatile storage device being configured to store a page table comprising a respective page table entry for each page of the plurality of pages, the respective page table entry of a respective page indicating a respective physical address of the memory and indicating whether the respective page was updated after receiving the checkpoint command;
wherein the checkpoint operation comprises: generating a page table copy by copying the page table; and, in response to receiving data that are to be written to a page of the plurality of pages, and in the case that, in the page table copy, the respective page table entry of the page indicates that the page was not updated after receiving the checkpoint command:
storing the data in the non-volatile FIFO buffer,
generating a page data copy by copying the respective page data of the page to a further physical address of the non-volatile memory device different from the respective physical address, and
merging the data stored in the non-volatile FIFO buffer with the page data copy.

2. The memory system according to claim 1,
wherein the checkpoint operation further comprises adapting, in the page table copy, the respective page table entry of the page to indicate the further physical address and/or to indicate that the page was updated after receiving the checkpoint command.

3. The memory system according to claim 1,
wherein the memory controller is further configured to, in response to receiving the data that are to be written to the page and in the case that the respective page table entry of the page indicates that the page was updated after receiving the checkpoint command, merging the data with the page data of the page without storing them in the non-volatile FIFO buffer first.

4. The memory system according to claim 1,
wherein the checkpoint operation further comprises: for each page table entry in the page table, writing the respective page data of the respective page to the non-volatile storage device after generation of the page data copy.

5. The memory system according to claim 4,
wherein, when writing the respective page data of the respective page of a respective page table entry the non-volatile storage device, the checkpoint operation further comprises adapting the respective page table entry to indicate a physical address of the non-volatile storage device to which the respective page data are written.

6. The memory system according to claim 1,
wherein the non-volatile memory device provides the non-volatile FIFO buffer.

7. The memory system according to claim 1,
wherein the non-volatile memory device is or includes at least one of: a remanent-polarizable non-volatile random-access memory, a magnetoresistive random-access memory, or a resistive random-access memory.

8. The memory system according to claim 1, further comprising a memory module including the non-volatile memory device, the non-volatile storage device, the memory controller, and the non-volatile FIFO buffer; and wherein the checkpoint command and the data are received via a memory interface of the memory module, the memory interface being a Non-Volatile Memory Express over Compute Express Link interface.

9. The memory system according to claim 1,
wherein the page table is associated with a corresponding namespace.

10. The memory system according to claim 1,
wherein the page table further comprises a checkpoint reference indicating which checkpoint the page table is associated with; and
wherein the checkpoint operation further comprises adapting the checkpoint reference of the page table copy to indicate a next checkpoint or adapting the checkpoint reference of the page table to indicate the checkpoint.

11. A method for generating a checkpoint of a memory device, the method comprising:
generating a page table copy by copying a page table, the page table comprising a respective page table entry for each page of a plurality of pages of the memory device, the respective page table entry of a respective page indicating a respective physical address of the memory device and indicating whether the respective page was updated after receiving a checkpoint command;
in response to receiving data that are to be written to a page for which the respective page table entry of the page table copy indicates that the page was not updated after receiving the checkpoint command, the following occurs:
storing the data in a non-volatile first in first out (FIFO) buffer,
generating a page data copy by copying the respective page data of the page to a further physical address of the memory device different from the respective physical address, and
merging the data with the page data copy.

12. The method according to claim 11, further comprising:
adapting, in the page table copy, the respective page table entry of the page to indicate the further physical address and/or to indicate that the page was updated after receiving the checkpoint command.

13. The method according to claim 11, further comprising:
in response to receiving data that are to be written to a page for which the respective page table entry of the page table copy indicates that the page was updated after receiving the checkpoint command, merging the data with the page data of the page without storing them in the non-volatile FIFO buffer first.

14. The method according to claim 11, further comprising:
for each page table entry in the page table, writing the respective page data of the respective page to a non-volatile storage device after generation of the page data copy.

15. The method according to claim 14, further comprising:
adapting the respective page table entry to indicate a physical address of the non-volatile storage to which the respective page data are written.

16. The method according to claim 11,
wherein the memory device is a non-volatile memory device providing the non-volatile FIFO buffer.

17. The method according to claim 16,
wherein the non-volatile memory device is or includes at least one of: a remanent-polarizable non-volatile random-access memory, a magnetoresistive random-access memory, or a resistive random-access memory.

18. The method according to claim 16,
wherein the non-volatile memory device and the non-volatile FIFO buffer are arranged within a memory module, and wherein the method further comprises receiving the data via a Non-Volatile Memory Express over Compute Express Link interface of the memory module.

19. The method according to claim 11,
wherein the page table is associated with a corresponding namespace.

20. The method according to claim 11,
wherein the page table further comprises a checkpoint reference indicating which checkpoint the page table is associated with; and
wherein the method further comprises adapting the checkpoint reference of the page table copy to indicate a next checkpoint or adapting the checkpoint reference of the page table to indicate the checkpoint.
